(19) United States
(12) Patent Application Publication
(10) Pub. No.: US 2026/0161424 A1
(43) Pub. Date: Jun. 11, 2026

(54) System And Method For Configuring A Routine For Execution

(71) Applicant: OneStream Software LLC, Birmingham, MI (US)

(72) Inventors: Lukas J. Heberling, Chicago, IL (US); Andrew M. Shea, New York, NY (US)

(73) Assignee: OneStream Software LLC, Birmingham, MI (US)

(21) Appl. No.: 19/209,861

(22) Filed: May 16, 2025

Related U.S. Application Data
(60) Provisional application No. 63/648,439, filed on May 16, 2024.

(51) Int. Cl. G06F 9/448; G06F 3/0484; G06F 8/30

(52) U.S. Cl. CPC G06F 9/4488; G06F 3/0484; G06F 8/315

(57) ABSTRACT

A computer-implemented method is presented for configuring a routine for execution in a computing environment. The method includes: receiving a routine; generating a state machine by recursively parsing the routine to extract input parameters defined by the routine; receiving a request to use the routine; identifying an initial state for the state machine; setting a current state of the state machine to the initial state; and generating a workflow for collecting values for the input parameters in the set of input parameters from a user, where the generation of the workflow includes rendering a user interface in accordance with the current state of the state machine.

### CROSS REFERENCE TO RELATED APPLICATIONS

This application claims the benefit of U.S. Provisional Application No. 63/648,439, filed May 16, 2024. The entire disclosure of the above application is incorporated herein by reference.

### FIELD

The present disclosure relates to system and method for configuring a routine for execution.

### BACKGROUND

Callable data science functions known as routines are commonly embedded in existing applications, processes and software solutions. Routines take in a predefined input provided by a user and provide some output such as model forecast predictions, classified anomalies, data transformations, etc. Routines are written in programming languages by software developers. On the other hand, routines may be leveraged and executed by end users with limited or no background in software development. Thus, there is a need for a system and method that bridges this gap and enables end users to easily configure routines for execution in a computing environment.

This section provides background information related to the present disclosure which is not necessarily prior art.

### SUMMARY

This section provides a general summary of the disclosure, and is not a comprehensive disclosure of its full scope or all of its features.

In one aspect, a computer-implemented method is presented for configuring a routine for execution in a computing environment. The method includes: receiving a routine from a data store, where the routine is written in a general-purpose programming language and defines a set of input parameters needed to execute the routine; generating a state machine by recursively parsing the routine to extract input parameters defined by the routine; receiving a subsequent request to use the routine; identifying an initial state for the state machine; setting a current state of the state machine to the initial state; and generating a workflow for collecting values for the input parameters in the set of input parameters from a user.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a diagram of a system for configuring execution of a routine in a computing environment.

FIG. 2 is a flowchart illustrating a proposed method for configuring a routine for execution in a computing environment.

FIG. 3 is a flowchart illustrating the steps of a workflow for collecting input parameter values from a user.

FIG. 4 is a flowchart illustrating how to recursively parse a routine to extract input parameters defined by the routine.

FIGS. 5A-5F are screenshots depicting the workflow and the associated user interfaces for the Kalman Filter routine.

Corresponding reference numerals indicate corresponding parts throughout the several views of the drawings.

### DETAILED DESCRIPTION

Example embodiments will now be described more fully with reference to the accompanying drawings.

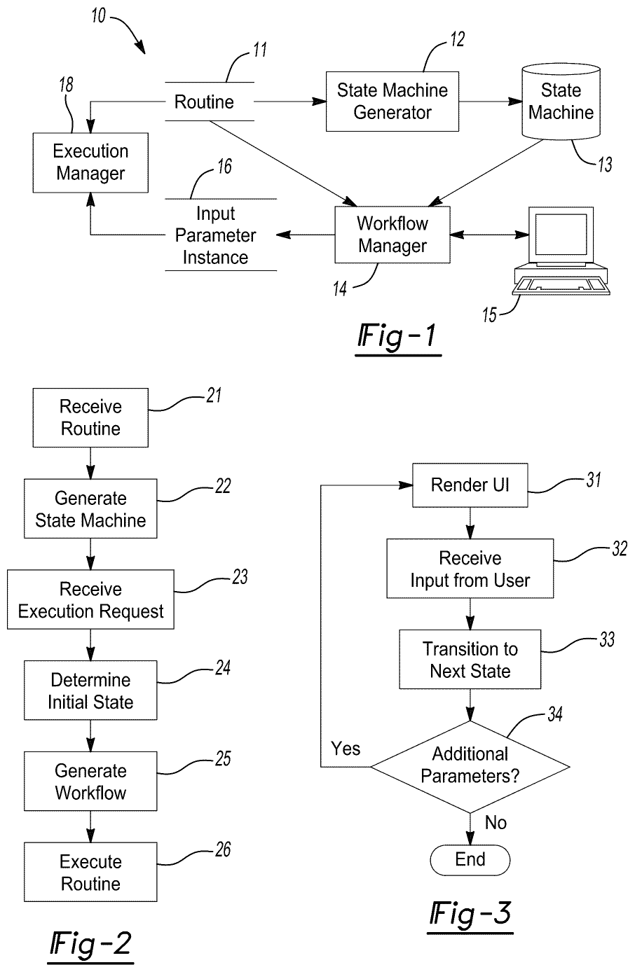

FIG. 1 depicts a system 10 for configuring execution of a routine in a computing environment. The system is comprised generally of a state machine generator 12, a workflow manager 14, and an execution manager 18. A library of routines 11 is made available to the system. Each routine is written in a general-purpose programming language and defines a set of input parameters needed to execute the routine. In an example embodiment, the general-purpose programming language is further defined as Python although other types of programming languages are contemplated by this disclosure. The system may further include a commercially available software development tool (not shown), such as PyCharm or Visual Studio Code.

The state machine generator 12 is configured to receive a selected routine from the library of routines 11 and operates to generate a state machine, where the state machine represents a workflow for collecting values for the input parameters defined in the routine. As further described below, the state machine is generated by recursively parsing the routine to extract the input parameters defined in the routine. The state machine generated by the state machine generator 12 is in turn stored in a database 13 for subsequent use.

Upon receiving a request to use a given routine, the workflow manager 14 will generate a workflow for collecting values for the input parameters from a user. To do so, the workflow manager 14 retrieves the given routine from the library of routines and retrieves the corresponding state machine from the database 13. The workflow manager 14 interacts with a user interface (e.g., a display device) to collect values for the input parameters from the user. Once input has been collected for each of the input parameters defined by the given routine, the workflow manager saves an instance of the input parameters in a data store 16 for subsequent processing.

Lastly, a request to execute the given routine is received by the execution manager 18. The execution manager 18 retrieves the instance of the input parameters matching the request and executes the given routine using the values of the input parameters residing in instance. It is to be understood that only the relevant components are discussed in relation to FIG. 1, but that other components may be needed to control and manage the overall operation of the system.

FIG. 2 provides an overview of the method for configuring a routine for execution in a computing environment. First, a selected routine is received at 21 from the library of data routines. A state machine is generated by recursively parsing the routine to extract the input parameters defined in the routine as indicated at 22. In this way, the state machine represents a workflow for collecting values for the input parameters defined in the routine.

Upon receiving a request to use a given routine at 23, the state machine is used to control a workflow for collection values of input parameters defined the given routine. As a starting point, a determination is made as to the initial state of the state machine as indicated at 24. In the example embodiment, the initial state is recorded in the state machine during the creation the state machine. Once the initial state has been identified, the current state of the state machine is set to this initial state and a workflow is generated using the state machine as indicated at 25.

With reference to FIG. 3, the basic steps involved in controlling the workflow are described. A user interface is rendered on a display device at 31 in accordance with the current state of the state machine. It is understood that the user interface is configured to capture input for one or more input parameters defined in the given routine.

By interacting with the user interface, the user inputs values for the input parameters shown on the display device as indicated at 32. After input values for the input parameters, the user then navigates to the next user interface in the workflow. The navigation instruction provided by the user serves as an indicator for transitioning to the next state in the state machine. In some instances, the input values and/or other input provided by the user may also serve as a basis for selecting the next state to transition to in the state machine.

In accordance with the indicator for transitioning, the state machine transitions to the next state at 33 and thereby changes the current state of the state machine. These steps are repeated until input has been received for each of the input parameters defined in the given routine as indicated at 34.

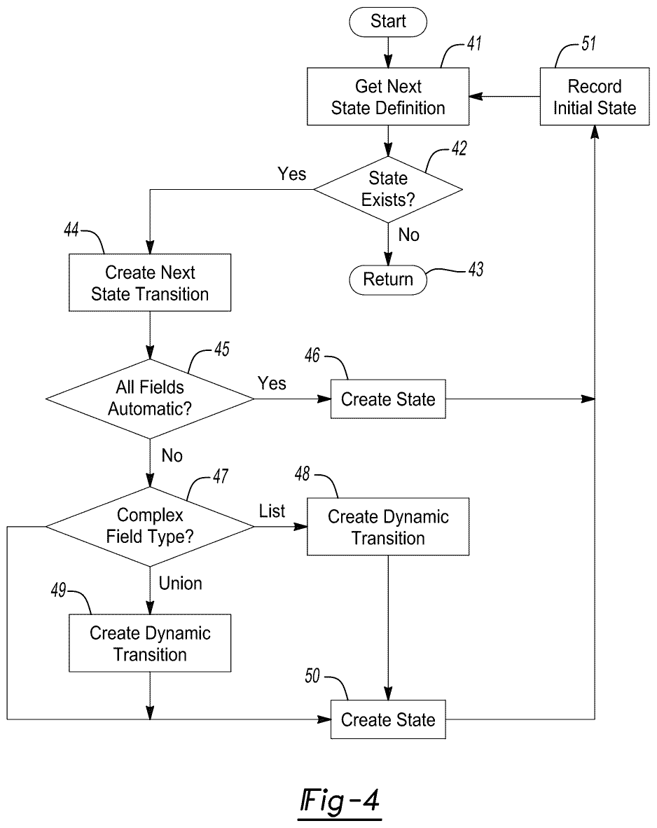

FIG. 4 further depicts an example technique for recursively parsing a routine to generate a state machine. To illustrate the recursive process, the steps in the figure will be described in relation to an example Kalman Filter routine. The relevant sections of source code for the Kalman Filter routine are set forth in the appendix below. It is readily understood by those skilled in the art how this technique can be extended to most any routine.

As a starting point, a first state definition is retrieved at 41 from the source code of the routine. In the Kalman Filter example, the first state definition is entitled the SourceDefinition state as shown below.

```
StateDefinitionContext(
    state_title=“Source Data Definition”,
    state_name=“SourceDefinition”,
    view_callback=cls.get_source_definition_view,
    next_state=“DateRange”,
    initial=True,
source_data_definition: TimeSeriesTableDefinition = InputParam(
  state_name=“SourceDefinition”,
  title=“Source Data Definition”,
  description=“The source data definition.”,
  input_component=InputComponentType.COMBOBOX,
```

As indicated by the state definition, the SourceDefinition state will transition to the DateRange state as the next state of the state model. Thus, a transition to this next state is created in the state model as indicated at 44. The name of the state, “SourceDefintition” can be used to retrieve one or more input parameters associate with the state. In this case, the SourceDefinition state references a TimeSeriesTableDefinition parameter. A determination is then made at steps 45 and 47 as to what type of parameter is the TimeSeriesTableDefinition parameter. Because the TimeSeriesTableDefinition parameter is a complex type, a state in the state machine is create for this parameter at step 50. The TimeSeriesTableDefinition parameter is determined to be a complex type because it itself is another Input Parameter Definition. Due to it being a complex type, the system recurses into the parameter type and begins gathering the state definitions within the TimeSeriesTableDefinition. This will create states nested within the SourceDefinition state.

Next, because TimeSeriesTableDefinition parameter is a complex parameter, the process will recurse through its associated inner states by looping back to step 41. With reference to the source code for the routine in the appendix below, the inner states for the TimeSeriesTableDefinition parameter include the Source Connection state and the DataForm state. Starting with the Source Connection state, this state definition is retrieved first at 41. The Source Connection state has a single parameter, i.e., data_connection which is also a complex type. Specifically, the data_connection parameter is a union of two objects: MetaFileTabularConnectionContext and SqlTabularConnectionContext. A dynamic transition is created at 44 for choosing which of the two objects to access when using the state machine.

```
  StateDefinitionContext(
      state_title=“Source Connection”,
      state_name=“SourceConnection”,
      view_callback=cls.get_data_connection_view,
      next_state=“DataForm”,
      initial=True,
class TimeSeriesTableDefinition(ParameterBaseModel):
    # region Input Parameters
    data_connection: Union[MetaFileTabularConnectionContext,
  SqlTabularConnectionContext] = InputParam(
      state_name=“SourceConnection”,
      title=“Source Connection”,
      description=“The connection information source data.”,
      input_component=InputComponentType.COMBOBOX,
```

It follows that the process will need to recurse each of these two objects to add their inner states.

For the MetaFileTabularConnectionContext object, the state for this object is the FileInfo state and it has only one parameter, file_path. File_path parameter is a string, i.e., an atomic type parameter.

```
class MetaFileTabularConnectionContext(XperiflowParameterBaseModel):
  file_path: str = InputParam(
      state_name=“FileInfo”,
      title=“File Path”,
      description=“The full file path to the file to query.”,
      input_component=InputComponentType.TEXTBOX,
  StateDefinitionContext(
    state_title=“Choose File Path”,
    state_name=“FileInfo”,
    view_callback=cls.get_file_info_view,
    next_state=None, # This means done (go up state level)
    initial=True,
```

As an atomic type parameter, a state object for the file_path parameter is created at 46 and the process proceeds to retrieve the next state definition. In this case, there are no further states for the MetaFileTabularConnectionContext object so processing continues with the SqlTabularConnectionContext object.

Likewise, the process will recurse through the states for the SqlTabularConnectionContext object. A first state for this object is the ChooseDatabaseResource state and it has only one parameter, database_resource. Database_resource parameters is also an atomic type parameter.

```
class SqlTabularConnectionContext(XperiflowParameterBaseModel):
    database_resource: str = InputParam(
      state_name=“ChooseDatabaseResource”,
      title=“Database Resource”,
      description=“The name of the database resource to connect to.”,
      input_component=InputComponentType.COMBOBOX,
      options_callback=“cls::get_database_resources”,
StateDefinitionContext(
      state_title=“Choose Database Resource”,
      state_name=“ChooseDatabaseResource”,
      next_state=“ChooseDatabaseSchema”, #
      Can be None (means done), str
  state, or str callback
      view_callback=cls.get_database_resource_view,
      initial=True,
```

As an atomic type parameter, a state object for the database_resource parameter is created at 46 and the process proceeds to retrieve the next state definition. In this case, the SqlTabularConnectionContext object has additional states to recurse through.

Continuing at step 41, the ChooseDatabaseSchema state is retrieved. The ChooseDatabaseSchema state has one parameter, i.e., database_schema, and it is an atomic type.

```
StateDefinitionContext(
  state_title=“Choose Database Schema”,
  state_name=“ChooseDatabaseSchema”,
  next state=“ChooseTable”, # Can be None (means done), str state, or str
callback
  view_callback=cls.get_database_schema_view,
database_schema: str = InputParam(
  state_name=“ChooseDatabaseSchema”,
  title=“Database Schema”,
  description=“The name of the database schema to connect to.”,
  input_component=InputComponentType.COMBOBOX,
  options_callback=“cls::get_database_schemas”,
```

As an atomic type parameter, a state object for the database_schema parameter is created at 46 and the process proceeds to retrieve the next state definition. ChooseDatabaseSchema state is defined separate from the ChooseDatabaseResource state because the options for the database scheme will depend on what the user selects for the database resource.

With continued reference to FIG. 4, a third state is also retrieved at 41 for the SqlTabularConnectionContext object. In particular, the ChoseTable state is retrieved and it has one parameter. The table_name parameter is an atomic type.

```
StateDefinitionContext(
    state_title=“Choose Table”,
    state_name=“ChooseTable”,
    view_callback=cls.get_tables_view,
    next_state=None, # This means done (go up state level)
table_name: str = InputParam(
  state_name=“ChooseTable”,
  title=“Table Name”,
  description=“The name of the table to query.”,
  input_component=InputComponentType.COMBOBOX,
  options_callback=“cls::get_tables”,
```

Again, a state object for the table_name parameter is created at 46 and the process proceeds to retrieve the next state definition. In this example, there are no more state for the SqlTabularConnectionContext object so we will return to retrieving states for the TimeSeriesTableDefinition parameter. Similar to the ChooseDatabaseSchema state, the ChoseTable state is a separate state because the options for the table will depend on what the user selects for the database schema and the database resource.

Continuing with the TimeSeriesTableDefinition parameter, the next state retrieved for this parameter is the DataForm state. The DataForm state has three parameters: dimension_columns, date_column and value_column as shown below. Each of these parameters are atomic type.

```
StateDefinitionContext(
    state_title=“Column Selection”, state_name=“DataForm”,
view_callback=cls.get_column_selection_view, next_state=None
    dimension_columns: list[str] = InputParam(
      state_name=“DataForm”,
      title=“Dimension Columns”,
      description=“The columns to use as dimensions.”,
      input_component=InputComponentType.COMBOBOX,
      options_callback=“cls::get_table_columns”,
  date_column: str = InputParam(
      state_name=“DataForm”,
      title=“Date Column”,
      description=“The column to use as the date.”,
      input_component=InputComponentType.COMBOBOX,
      options_callback=“cls::get_table_columns”,
  value_column: str = InputParam(
      state_name=“DataForm”,
      title=“Value Column”,
      description=“The column to use as the value.”,
      input_component=InputComponentType.COMBOBOX,
      options_callback=“cls::get_table_columns”,
```

A single state object is created for these three parameters at 46 and before the process retrieves the next state definition. Because this is the last state associated with the TimeSeriesTableDefinition parameter, processing returns to the most outer loop.

With processing complete for the SourceDefinition state, processing moves to the DateRange state. The DateRange state has two input parameters: start_date and end_date. Both of these parameters are atomic.

```
StateDefinitionContext(
    state_title=“Date Range”,
    state_name=“DateRange”,
    next_state=“FilterParams”,
    view_callback=cls.get_date_range_view,
start_date: dt.datetime = InputParam(
  state_name=“DateRange”,
  title=“Start Date”,
  description=“The start date of the data to filter.”,
  input_component=InputComponentType.DATESELECTOR,
end_date: dt.datetime = InputParam(
  state_name=“DateRange”,
  title=“End Date”,
  description=“The end date of the data to filter.”,
  input_component=InputComponentType.DATESELECTOR,
```

A state object for these two input parameters is created at 46 and the process proceeds to retrieve the next state definition.

FilterParams is the third and final state for the Kalman Filter routine. The FilterParams state contains one parameter of atomic type, i.e., n_seasons.

```
StateDefinitionContext(
      state_title=“Filter Parameters”,
        state_name=“FilterParams”,
        next_state=None,
    view_callback=cls.get_filter_params_view,
n_seasons: Optional[int] = InputParam(
  state_name=“FilterParams”,
  title=“Number of Seasons”,
  description=“The number of seasons in the data.”,
  input_component=InputComponentType.TEXTBOX,
  options_callback=“get_n_seasons_options”,
```

A state object for this parameter is created at 46 and the process proceeds to retrieve the next state definition. Because there are no more state definitions to retrieve, the recursive process is complete as indicated at 42 and 43.

While looping over all of the state definitions, the system keeps track of which state definition is the single initial state for the input definition. If the initial state is an input definition itself, then the inner initial state will become the total initial state. This initial state could be nested with N number of Input Definitions. The initial state is recorded in the state machine as indicated at 51.

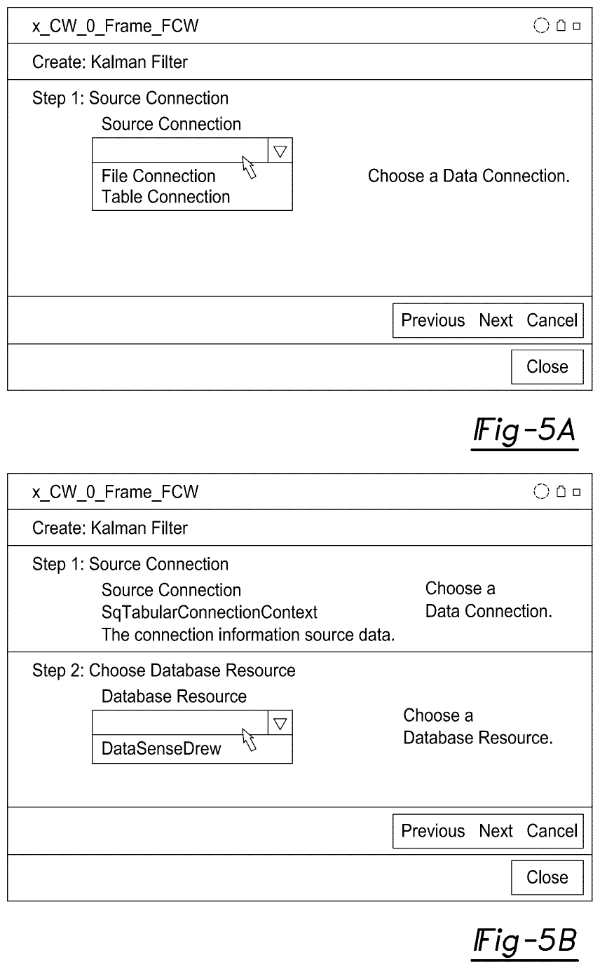

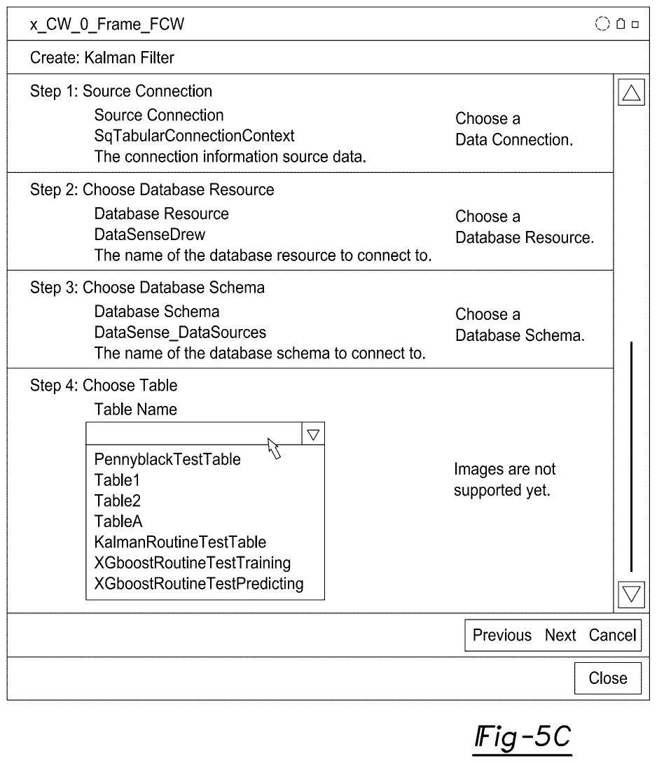

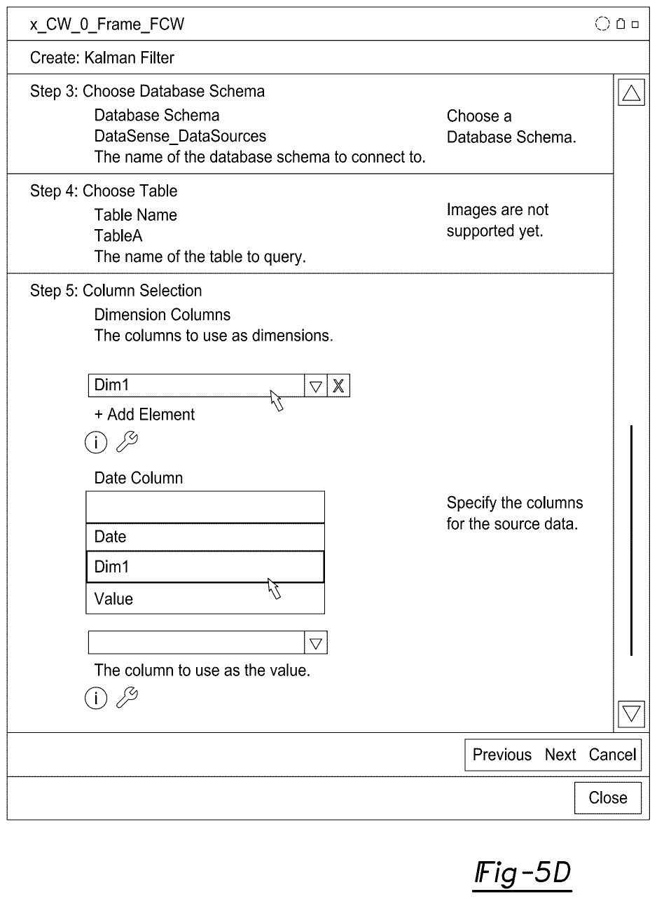

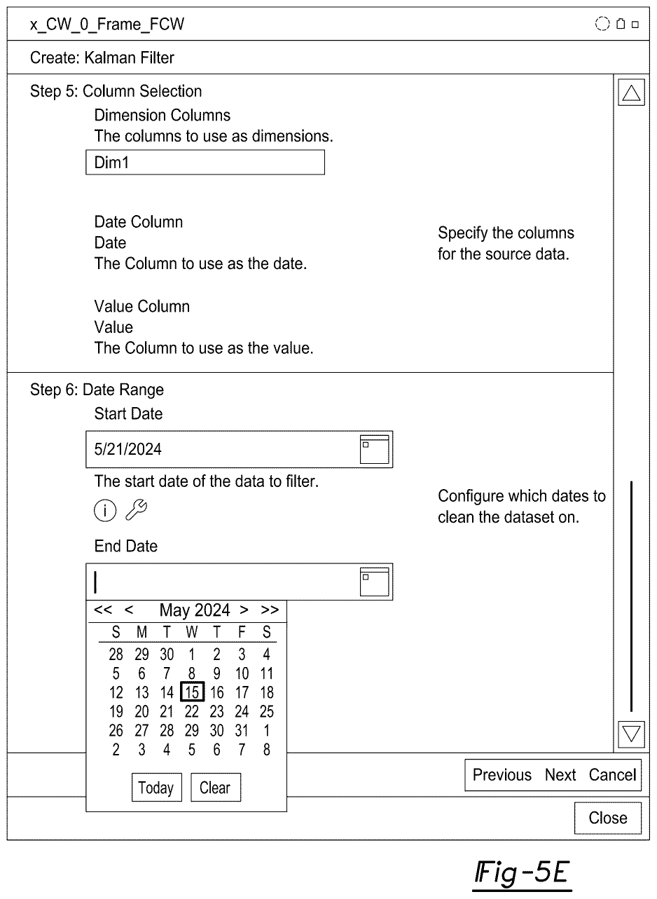

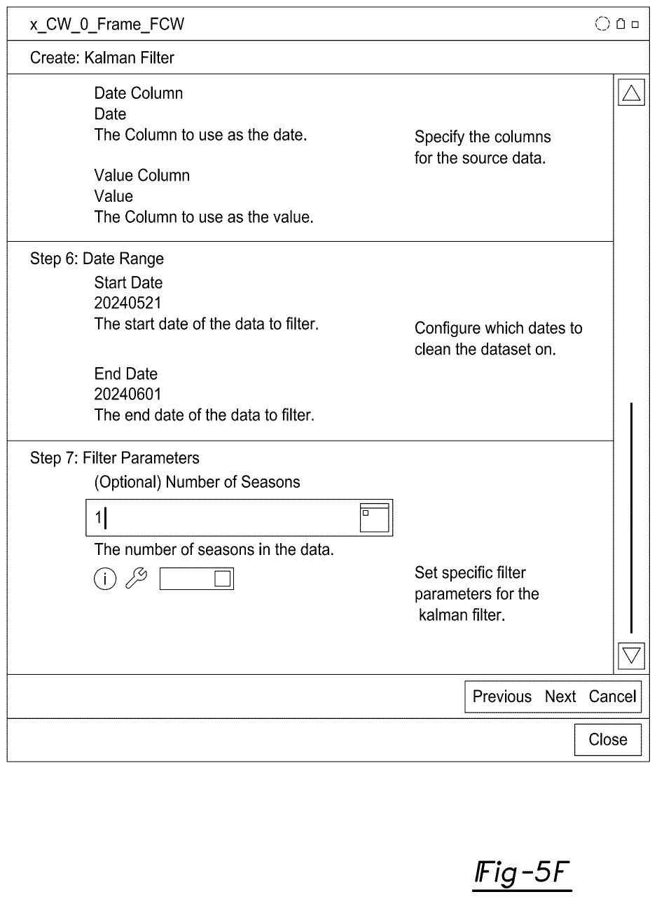

Subsequently, a user may request to use a requested routine via the workflow manager 14. As noted above, the workflow manager will access the requested routine in the library of routines 11 and the state machine in the database 13. The workflow manager will render different user interfaces in accordance with the state machine for the requested routine and thereby create a workflow to collect values for the input parameters from the user. FIGS. 5A-5G depict the workflow and the associated user interfaces for the Kalman Filter routine.

The techniques described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Some portions of the above description present the techniques described herein in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the described techniques include process steps and instructions described herein in the form of an algorithm. It should be noted that the described process steps and instructions could be embodied in software, firmware or hardware, and when embodied in software, could be downloaded to reside on and be operated from different platforms used by real time network operating systems.

The present disclosure also relates to an apparatus for performing the operations herein. This apparatus may be specially constructed for the required purposes, or it may comprise a computer selectively activated or reconfigured by a computer program stored on a computer readable medium that can be accessed by the computer. Such a computer program may be stored in a tangible computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various systems may also be used with programs in accordance with the teachings herein, or it may prove convenient to construct more specialized apparatuses to perform the required method steps. The required structure for a variety of these systems will be apparent to those of skill in the art, along with equivalent variations. In addition, the present disclosure is not described with reference to any particular programming language. It is appreciated that a variety of programming languages may be used to implement the teachings of the present disclosure as described herein.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for configuring a routine for execution in a computing environment, comprising:
receiving, by a computer processor, a routine from a data store, where the routine is written in a general-purpose programming language and defines a set of input parameters needed to execute the routine;
generating, by the computer processor, a state machine by recursively parsing the routine to extract input parameters defined by the routine;
receiving, by the computer processor, a request to use the routine;
identifying an initial state for the state machine;
setting a current state of the state machine to the initial state; and
generating, by the computer processor, a workflow for collecting values for the input parameters in the set of input parameters from a user, where the generation of the workflow includes:
a) rendering a user interface in accordance with the current state of the state machine, where the user interface is configured to capture input for one or more input parameters in the set of input parameters;
b) receiving, via the user interface, input for the one or more input parameters, along with an indicator for transitioning to a next state in the state machine;
c) transitioning to the next state in the state machine in accordance with the indicator (and the input for the one or more input parameters) and thereby change the current state of the state machine;
d) repeating steps a)-c) until input has been received for each of the input parameters in the set of input parameters.

2. The method of claim 1 wherein the general-purpose programming language is further defined as Python.

3. The method of claim 1 wherein generating a state machine further comprises
retrieving a definition for given state, where the definition for the given state is defined in the routine;
creating a transition for the given state in a state model;
determining input parameters associated with given state;
creating a state for the given state in the state model, where the state represented the input parameters associated with the given state; and
repeating these steps for each state definition defined in the routine.

4. The method of claim 1 wherein generating a state machine further comprises storing the state machine in a non-transitory storage medium for subsequent processing.

5. The method of claim 1 wherein the initial state for the state machine is defined in a state definition residing in the routine.

6. The method of claim 1 further comprises executing the routine using the input for each of the input parameters in the set of input parameters.

7. A non-transitory computer-readable medium having computer-executable instructions that, upon execution of the instructions by a processor of a computer, cause the computer to:
receive a routine from a data store, where the routine is written in a general-purpose programming language and defines a set of input parameters needed to execute the routine;
generate a state machine by recursively parsing the routine to extract input parameters defined by the routine;
receive a request to use the routine;
identify an initial state for the state machine;
set a current state of the state machine to the initial state; and
generate a workflow for collecting values for the input parameters in the set of input parameters from a user, where the generation of the workflow includes:
a) rendering a user interface in accordance with the current state of the state machine, where the user interface is configured to capture input for one or more input parameters in the set of input parameters;
b) receiving, via the user interface, input for the one or more input parameters, along with an indicator for transitioning to a next state in the state machine;
c) transitioning to the next state in the state machine in accordance with the indicator (and the input for the one or more input parameters) and thereby change the current state of the state machine;
d) repeating steps a)-c) until input has been received for each of the input parameters in the set of input parameters.

8. The non-transitory computer-readable medium of claim 7 wherein the general-purpose programming language is further defined as Python.

9. The non-transitory computer-readable medium of claim 7 wherein generating a state machine further comprises
retrieving a definition for given state, where the definition for the given state is defined in the routine;
creating a transition for the given state in a state model;
determining input parameters associated with given state;
creating a state for the given state in the state model, where the state represented the input parameters associated with the given state; and
repeating these steps for each state definition defined in the routine.

10. The non-transitory computer-readable medium of claim 7 wherein the initial state for the state machine is defined in a state definition residing in the routine.

11. The non-transitory computer-readable medium of claim 7 further comprises executing the routine using the input for each of the input parameters in the set of input parameters.
